(19) United States
(12) Patent Application Publication
(10) Pub. No.: US 2012/0290267 A1
(43) Pub. Date: Nov. 15, 2012

(54) SYSTEM AND METHOD FOR MEASURING GHG EMISSIONS IN BIOPRODUCT PRODUCTION PROCESSES

(75) Inventors: Ricardo ARJONA ANTOLIN, Sevilla (ES); Maria de las Nieves Valenzuela Romero, Sevilla (ES); Beatriz Alonso Martinez, Madrid (ES); Raquel Diaz Molist, Madrid (ES); Rocio Garcia Encinas, Sevilla (ES); Maria Angeles Gutierrez Montero, Sevilla (ES); Jesus Yanez Vidal, Sevilla (ES); Laura Montes Garcia, Sevilla (ES); Jesus Lopez Lopez, Sevilla (ES); Macarena Marquez Pinuela, Sevilla (ES)

(73) Assignee: ABENGOA BIOENERGIA NUEVAS TECNOLOGIAS, S.A., Sevilla (ES)

(21) Appl. No.: 13/103,403

(22) Filed: May 9, 2011

(51) Int. Cl. G01F 15/06; G06F 15/00

(52) U.S. Cl. 702/188

(57) ABSTRACT

The method & system hereby described allows the calculation and determination of GHG emissions produced during the generation of bioproduct from different source materials. The method comprises capturing, processing and handling different parameters and data related to GHG emissions associated to every single process needed to produce bioproduct, in order to generate a total GHG emissions value by means of applying formulae to the captioned and processed isolated data referred to GHG emissions of every process.

### FIELD OF THE INVENTION

The invention hereby disclosed is related to the field of sustainability and environmental control in bioproduct production processes.

The objective of this procedure is a system and method for measuring GHG emissions associated to the conversion process of bioproduct.

### BACKGROUND

Bioproducts include building materials, pulp and paper, forest products, biofuels, bioenergy, starch-based and cellulose-based ethanol, bio-based adhesives, biochemicals, biodegradable plastics, etc. Bioproducts are active subjects of research and development, and these efforts have developed significantly since the turn of the 20/21st century, mainly driven by the environmental impact of petroleum use. Bioproducts derived from bioresources can replace much of the fuels, chemicals, plastics etc. that are currently derived from petroleum. For example bioenergy is sort of bioproduct which provides a renewable energy source, same applies to biofuels, bioliquids, biogas, renewable electricity and renewable thermal energy.

As an example of bioproduct, biofuels are gaining increased public and scientific attention, driven by factors such as oil price spikes, the need for increased energy security, and concern over greenhouse gas emissions from fossil fuels. Biofuels are used among others for ETBE production (gasoline additive), or for direct blending with gasoline or diesel. Being renewable energy sources, biofuels reduce CO2 emissions, and contribute to the security and diversification of the energy supply, while reducing the dependency on fossil fuels in the transportation and helping towards compliance with the Kyoto Protocol.

In order to produce bioproduct, such as biofuels like bioethanol and biodiesel, some processes need to be carried out, said processes produce emissions such as GHG.

Greenhouse gases (sometimes abbreviated GHG) are gases in an atmosphere that absorb and emit radiation within the thermal infrared range being the fundamental cause of the greenhouse effect. The primary greenhouse gases in the Earth's atmosphere are carbon dioxide, methane, nitrous oxide, among others.

Bioproduct has been promoted as a climate solution as well as for their energy security and domestic economic benefits; analysts often assume that, other than process emissions, bioproduct emit no net CO2 because their biogenic carbon was recently absorbed from the atmosphere.

Therefore, it seems to be clear that it may be uses bioproduct, as an alternative for other fossil fuel derived thus producing less GHG, but it needs to be know how much GHG emissions the production of said bioethanol involves in order to determine whether the use of bioproduct instead other fossil fuels could benefit the reduction of emissions affecting global warming, hence it needs to be able to accurately calculate a GHG emission level associated to the entire process of producing said bioproduct, being said GHG emission level derived from the GHG emissions related to every single process used for the transformation of raw materials.

### SUMMARY OF THE INVENTION

The object of the invention is a system and a method for calculating GHG emissions associated to the production of bioproduct from at least one source material. The source material may be selected from the group consisting of cereals, sugar cane, straw, energy crops, forestry material, forestry residues, organic waste, wine alcohol, aquaculture and fishery residues and oleaginous crops.

The method and system hereby described can produce different GHG (greenhouse gas) emission data by processing at least one variable related to GHG (greenhouse gas) emissions generated from each process used for the production of bioproduct at a site. Said emission data may comprise:
An emission factor resulting from processing the at least one variable related to GHG (greenhouse gas) emissions produced by each bioproduct production process, said emission factor being calculated using the processing unit/and or an emissions modelling module of the system.
An Activity Data value resulting from processing the at least one variable related to the GHG (greenhouse gas) emission produced by each bioproduct production process, said activity data being calculated using the processing unit/and or an emissions modelling module of the system.
An emission value resulting from processing the emission factor along with an activity data value, said emission value being calculated using the processing unit/and or a emissions modelling module of the system resulting from applying, for each process, the following formula:

ActivityData_{process}·EmssionFactor_{process}
An emission level embracing all the emission values related to all the processes needed to transform the source material into bioproduct. This is accomplished by applying the following formula:

$$EmissionLevel = {\sum }_{i = 1}^{n} ( {ActivityData}_{i} \cdot {EmissionsFactor}_{i} )$$

According to what has been explained above, the system of the invention comprises:
at least a processing unit adapted to at least execute instructions related to the calculation of the GHG (greenhouse gas) emissions level in bioproduct production processes,
a plurality of sensors arranged along the site adapted to monitor, collect and report at least one variable related to GHG (greenhouse gas) emissions generated from the production of bioproduct at the site,
data transmission means adapted to transmit data and connected to the processing unit and at least to the plurality of sensors,
at least one database accessible by the processing unit by means of the data transmission means, and
a GHG (greenhouse gas) emissions modelling module embodied as software and connected to the processing unit and to at least one variable related to the GHG (greenhouse gas) emissions to produce GHG (greenhouse gas) emissions data associated to each process of bioproduct production at the site to generate a GHG (greenhouse gas) emissions level.

Preferably, the data regarding the at least one variable related to GHG (greenhouse gas) emissions generated from the production of bioproduct at the site collected by the plurality of sensors located at the site is included in the at least one database.

According to a preferred embodiment, the plurality of sensors are adapted to monitor and report data selected from the group consisting of a flow rate, temperature, pressure, weight, moisture, flow composition, energy exported, particulate matter, gas composition, energy produced, energy consumed, raw fuel consumed, a waste stream, equipment emission value for at least one process used to transform the source material into bioproduct, installation emission value for at least one process used to transform the source material into bioproduct, process emission for at least one process used to transform the source material into bioproduct, and emission value for at least one process used to transform the source material into bioproduct.

The at least one processing unit preferably comprises:
at least one processor adapted to process at least the GHG (greenhouse gas) emissions data,
at least one memory connected to the at least one processor, and
storage means adapted to store at least the instructions executed by the at least one processor.

The data transmission means is preferably selected from the group consisting of: wired communication means, wireless communication means and near field communication means.

The bioproduct further comprises a co-product of bioproduct. The bioproduct may preferably be, among others, biofuel like biodiesel or bioethanol.

According to a preferred embodiment, the source material may be selected from the group consisting of: cereals, sugar cane, straw, energy crops, forestry material, forestry residues, organic waste, wine alcohol, aquaculture and fishery residues and oleaginous crops.

The system may further comprise at least one interface to the processing unit, adapted to output a report of the GHG (greenhouse gas) emissions level.

Preferably, the GHG (greenhouse gas) emissions data associated to each process of bioproduct production at the site is selected from the group consisting of:
at least one emission factor to each process resulting from processing the at least one variable related to GHG (greenhouse gas) emissions produced by each bioproduct production process,
at least one activity data value resulting from processing the at least one variable related to GHG (greenhouse gas) emissions produced by each bioproduct production process,
at least one emission value resulting from processing the emission factor along with an activity data value, and
   an emission level resulting from summing all the emission values.

The method of the invention mainly consists of four consecutive steps:

a) Bioproduct production process assessment: In this first step has been identified the different processes (disaggregated in stages and also in tasks) involved in the bioproduct production from at least a source material (i.e. biomass (biodegradable fraction of products, waste and residues from biological origin from agriculture—including vegetal and animal substances—, forestry and related industries including fisheries and aquaculture, as well as the biodegradable fraction of industrial and municipal waste)) at the production plants. These stages (and corresponding tasks), are basically:
Stage 1: Own consumed energy generation: The production plants could be differentiated in two types in function of the existence of own energy generation installations or not, and the energy is purchased to a defined supplier. The energy is produced in terms of electricity (partly self-consumed and exported) and steam in CHP using NG as fuel. The exhaust gases are also considered by their energy content.
Stage 2: Bioproduct conversion processes: Along the production processes needed to convert the raw material into bioproduct and its co-product the common processes are identified as those previous to the separation of product and co-product. These are listed as: milling, mashing, cooking, liquefaction, fermentation, distillation, dehydration, boiler, cogeneration unit, gas turbine, steam turbine, feedstock preparation, biomass pre-treatment, solid/Liquid separation, gasification, cooling, gas cleaning, compression, catalysis reaction, enzymatic hydrolisys, selexol, transesterification, evaporation, mixing, drying, stripping, degumming, filtration, recovery refining, purification, clarification, acid estherification, condensation, vents, and rectification.
Stage 3: Processes over bioproduct co-products: This stage should be considered when associated to those processes needed to obtain the co-product of the bioproduct production at the required sell conditions (as pellets and with a defined humidity). Said co-product may be pure waste products resulting from obtaining the bioproduct such as sewage water or may be valuable products like DDGS (Destilled Dry Grains with Solubles) which would need individual treatments like: solid/liquid separation, evaporation, drying process, pelletization; or said co-product may be a valuable product produced along with the bioproduct, in both cases emissions are produced and are thus duly accounted.

Different co-products may be considered, such as, among others: biofuels; bioliquids; biogas; chemicals; feed raw; renewable electricity; renewable thermal energy; bioplastics; resins and CO₂.

Different tasks are considered under the three previously defined stages, in all of them the energy and raw material consumption, as well as the wastes generation will be perfectly identified and calculated.

a) Selection of calculation method (formula): The GHG emissions associated with the entire acquisition process can be calculated according to the following formula, for the “n” previously identified steps:

$$EmissionLevel = {\sum }_{i = 1}^{n} ( {ActivityData}_{i} \cdot {EmissionsFactor}_{i} )$$

In which:
Activity data is a characteristic parameter of the activity or tasks of the equipment, installations, processes or vehicles associated with a given source, which allows determining their emissions for a given period through calculation. Examples of activity data are the fuel consumption, the consumption of raw material, the distance covered by vehicles, etc. The value of each activity data could vary in each production plant and the case of use of defined raw material type. The resulting activity data for a defined subtask could be composed by a combination of several variables and constant factors. This activity data value may be obtained in different ways, and it is the result of manipulating (by different calculations) one or more variables related to GHG (greenhouse gas) emissions generated from each process used for the production of bioproduct at a site collected from a plurality of sensors arranged along the site.
Emission Factor is a parameter that indicates the quantity of a particular contaminant emitted from a particular activity by unit of product, volume, duration, quantity of raw material or fuel etc, and that is by unit of what has been designated as “activity data”. The value of each emissions factor could vary in each production plant and the case of use of defined raw material type. This emission factor value may be obtained in different ways, and it is the result of manipulating (by different calculations) one or more variables related to GHG (greenhouse gas) emissions generated from each process used for the production of bioproduct at a site.

It is worth mentioning that both the activity data and the emission factor may be calculated from the same variable/s, or it is also feasible to calculate the activity data value from one or more variable and the emission factor from one or more variables different to those used to calculate the activity data; furthermore when using more than one variable to calculate either the emission factor or the activity data, it might happen than one of those variables is used to calculated both the activity data and the emission factor.

c) Search and selection of the best available data (activity data and emissions factors, for the calculation formula) for each production plant and raw material type.
d) Calculation performance: Using the data selected as described before for each subtask in the corresponding formula, allows getting the total emission value expressed in g CO2 eq/MJ bioproduct, as result of adding all the stages involved.

The sequential calculation per task is the same:
1) Selection of the corresponding subtask per each task depending of the production plant and raw material type.
2) Selection of the variables needed in each subtask to be incorporated within the calculation formula. These variables cover both emissions factor and activity data.
3) Calculation performance using the corresponding formula and variables for each subtask.
4) Results for each subtask and the final result of the stage analyzed adding the individual result of each task integrated for its corresponding sub tasks.

### BRIEF DESCRIPTION OF THE DRAWINGS

For a better understanding of the present invention, reference will now be made, by way of example only, to the accompanying drawings in which:

FIG. 1 depicts a diagram of the system and method of the invention.

### DETAILED DESCRIPTION OF A PREFERRED EMBODIMENT

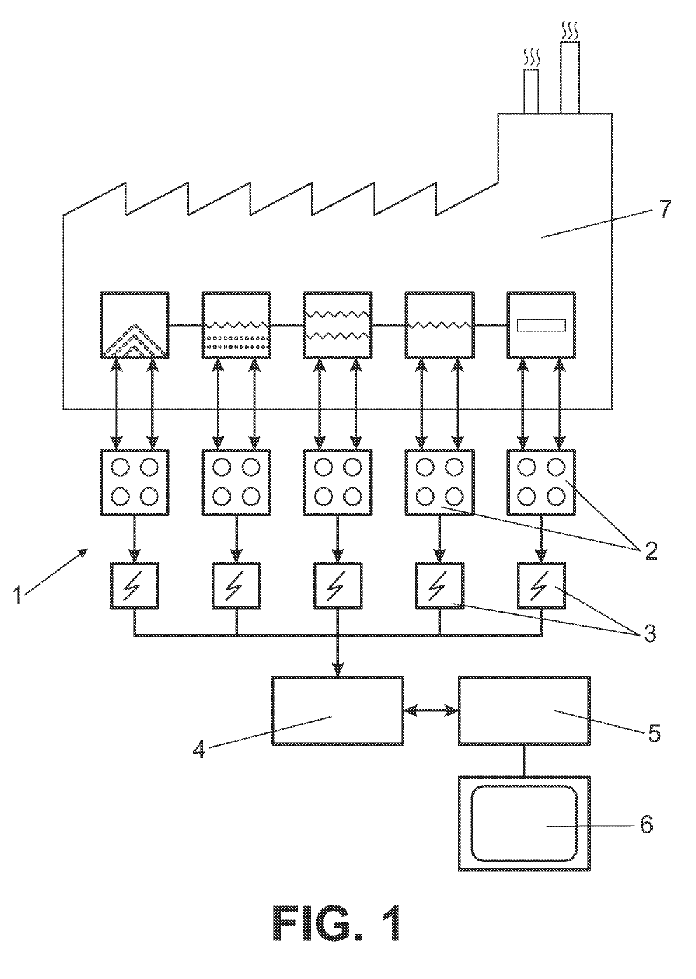

Following the reference signs adopted in FIG. 1, there now follows a more detailed description of an embodiment of the invention.

As depicted in FIG. 1, the system (1) of the invention for measuring a GHG (greenhouse gas) emissions level in bioproduct [standalone bioethanol or along with a co-product of bioethanol] production processes using a source material [such as wine alcohol] at a site (7) carries out several data captions and calculations using at least a processing unit (5), which is connected to a (greenhouse gas) emissions modelling module (4), which can perform the calculations helped by the processing unit (5); provided with at least one interface (6) adapted to output a report of the GHG (greenhouse gas) emissions level. Said processing unit (5) is furnished with at least one processor adapted to execute instructions and perform calculations related to the measurement of the GHG (greenhouse gas) emissions level in bioproduct production processes; in order to do so, the processor may process at least one of the following:
GHG (greenhouse gas) emissions data, and
at least one variable related to GHG (greenhouse gas) emissions,

In order to do so, the processing unit (5) and the (greenhouse gas) emissions modelling module (4) are helped by at least one memory connected to the at least one processor, and storage means adapted to store at least the instructions executed by the at least one processor. Said processing unit (5) is strongly related to the GHG (greenhouse gas) emissions modelling module (4) to which it is connected, hence the GHG (greenhouse gas) emissions modelling module (4) may use, at least partially, the processing capabilities of the processing unit (5) to process the at least one variable related to GHG (greenhouse gas) emissions and/or the GHG (greenhouse gas) emissions data associated to each process of bioproduct production at the site (7) to, finally, calculate a GHG (greenhouse gas) emissions level, said at least one variable related to GHG (greenhouse gas) emissions is collected by a plurality of sensors (2) arranged along the site (7) that monitor, collect and report said at least one variable related to said GHG (greenhouse gas) emissions which may be related to individual processes, part of the entire process of producing bioproduct from a source material.

The source material can be, among other biomass, cereals, sugar cane, straw, energy crops, forestry material, forestry residues, organic waste, wine alcohol, aquaculture and fishery residues and oleaginous crops.

This means that the sensors (2) may collect at least one variable related to GHG (greenhouse gas) emissions or direct values of GHG (greenhouse gas) factor and activity data values associated to each process. The data collected by the sensors (2) is transmitted to at least one database accessible by the processing unit (5) by means of data transmission means (3), said data transmission means (3) may be connected at least to the plurality of sensors (2) and to the GHG (greenhouse gas) emissions modelling module (4), thus to the processing unit (5), said data transmission means (3) are also suitable for connecting the system (1) to a network.

The GHG (greenhouse gas) emissions data associated to each process of bioproduct production at the site generated by the processing unit (5) or the (greenhouse gas) emissions modelling module (4) from the at least one variable related to GHG (greenhouse gas) emissions is listed as follows:
an emission factor resulting from processing the at least one variable related to GHG (greenhouse gas) emissions produced by each bioproduct production process,
an activity data value resulting from processing the at least one variable related to GHG (greenhouse gas) emissions produced by each bioproduct production process. In this preferred embodiment the activity data is referred to Thermal losses in a Gas Turbine [GT_Perd]. This activity data value is measured in MW and is determined from the following variables related to GHG (greenhouse gas) emissions: gas consumption in the Gas Turbine (GT) [1A], shaft power of GT [10] and thermal power of exhausted gases [10]. So the (greenhouse gas) emissions modelling module (4) cooperating with the processing unit (5) performs the calculation of said activity data, namely Thermal losses in a Gas Turbine (GT_Perd) using:

GT_{Perd}=1A−1C−1D
In an another embodiment of the object of the invention, the activity data may be referred to an energy of gases coming out from exhaust, in this case the GHG (greenhouse gas) emissions modelling module (4) cooperating with the processing unit (5) performs the calculation of said activity data, using:

$$H ( T ) = m * {\int }_{0}^{t} Cp \cdot d T$$

In yet another embodiment of the invention, the activity data may be related to vapour enthalpy and in this case the calculation is carried out by interpolating data, in this with a table comprising the physical properties of water and crossing the data comprised in said table with values related to pressure and temperature.

Then GHG (greenhouse gas) emissions level is calculated from the GHG (greenhouse gas) emissions values associated to each process of bioproduct production, which may be retrieved from the database, by means of the GHG (greenhouse gas) emissions modelling module (4). The GHG (greenhouse gas) emissions level is calculated by firstly calculating the activity data value from the at least one variable impacting emissions of the GHG (greenhouse gas) by any suitable calculation as detailed above, and the emission factor from at least one second variable impacting emissions of the GHG (greenhouse gas), by means of the GHG (greenhouse gas) emissions modelling module (4), and then calculating the emission value associated to each process, again by means of the GHG (greenhouse gas) emissions modelling module (4), using the following formula:

Emission Value=EmssionFactor·ActivityData

Once every Emission Value for each process is calculated, then the GHG (greenhouse gas) emissions level is calculated by means of the GHG (green-house gas) emissions modelling module (4) applying the following formula:

$$EmissionLevel = {\sum }_{i = 1}^{n} ( {ActivityData}_{i} \cdot {EmissionsFactor}_{i} )$$

Where, as detailed above:
[Activity data] is a characteristic parameter of an activity of equipment, installations and/or processes associated to the source material comprising the GHG (greenhouse gas) emissions associated to each process used to transform the source material into bioproduct, and
[Emission Factor] is the GHG (greenhouse gas) emissions data associated to each process used to transform the source material into bioproduct.

The system (1) of the invention allows the measurement of the GHG (greenhouse gas) emissions level which is the result or processing every single GHG (greenhouse gas) emission values associated to each process used to transform the source material into a bioproduct, said processes may comprise: milling, mashing, cooking, liquefaction, fermentation, distillation, dehydration, boiler, cogeneration unit, gas turbine, steam turbine, feedstock preparation, biomass Pre-treatment, solid/liquid separation, gasification, cooling, gas cleaning, compression, catalysis reaction, enzymatic hydrolisys, selexol, transesterification, evaporation, mixing, drying, stripping, degumming, filtration, recovery, refining, purification, clarification, acid esterification, condensation, vents, and rectification.

In a preferred embodiment of the invention the plurality of sensors (2) may be adapted to monitor and report flow rate, temperature, pressure, weight, moisture, flow composition, energy exported, particulate matter, gas composition, energy produced, energy consumed, raw fuel consumed, a waste stream, equipment emission value for at least one process used to transform the source material into bioproduct, installation emission value for at least one process used to transform the source material into bioproduct, process emission value for at least one process used to transform the source material into bioproduct, and contaminant emission value for at least one process used to transform the source material into bioproduct, and the transmission means (3) are selected amongst wired communication means, wireless communication means and near field communication means.

Another embodiment of the invention describes a method for measuring GHG (greenhouse gas) emissions resulting from producing bioproduct from a source material at a site, the method comprising:
retrieving from a plurality of sensors arranged along the site GHG (greenhouse gas) emissions data associated to each process of bioproduct production related to at least one variable impacting emissions of the GHG (greenhouse gas) resulting from bioproduct production at the site,
sending said GHG (greenhouse gas) emissions data associated to each process of bioproduct production at the site regarding at least one variable impacting emissions of the GHG (greenhouse gas) resulting from bioproduct generation at the site to a database accessible by at least a processing unit by means of transmission means to which said processing unit is connected,
retrieving, by means of a GHG (greenhouse gas) emissions modelling module embodied in software and connected to a processing unit capable of executing instructions embodied in said software, from the database said GHG (greenhouse gas) emissions data associated to each process of bioproduct production at the site regarding at least one variable impacting emissions of the GHG (greenhouse gas) resulting from bioproduct generation at the site;
calculating, by means of the GHG (greenhouse gas) emissions modelling module, GHG (greenhouse gas) emissions data associated to each process of bioproduct production from at least one variable impacting emissions of the GHG (greenhouse gas) resulting from bioproduct generation at the site, and
calculating, by means of the GHG (greenhouse gas) emissions modelling module, a GHG (greenhouse gas) emissions level from the GHG (greenhouse gas) emissions data associated to each process of bioproduct production retrieved from the database by means of the GHG (greenhouse gas) emissions modelling module applying the following formula:

$${Emissions}_{Taski} = {\sum }_{i = 1}^{n} ( {ActivityData}_{i} \cdot {EmissionsFactor}_{i} )$$

where:
[Emissions Task]i is the GHG (greenhouse gas) emissions level,
[Activity data] is a characteristic parameter of an activity of equipment, installations and/or processes associated to the source material comprising the GHG (greenhouse gas) emissions associated to each process used to transform the source material into bioproduct, and
[Emissions Factor] is the GHG (greenhouse gas) emissions data associated to each process used to transform the source material into bioproduct.

Another embodiment of the invention describes a method for measuring GHG (greenhouse gas) emissions resulting from producing bioproduct from a source material at a site, the method comprising managing bioproduct trading activities, the method comprising:
retrieving from a plurality of sensors arranged along the site GHG (greenhouse gas) emissions data associated to each process of bioproduct production related to at least one variable impacting emissions of the GHG (greenhouse gas) resulting from bioproduct production at the site,
sending said GHG (greenhouse gas) emissions data associated to each process of bioproduct production at the site regarding at least one variable impacting emissions of the GHG (greenhouse gas) resulting from bioproduct generation at the site to a database accessible by at least a processing unit by means of transmission means to which said processing unit is connected,
retrieving, by means of a GHG (greenhouse gas) emissions modelling module embodied in software and connected to a processing unit capable of executing instructions embodied in said software, from the database said GHG (greenhouse gas) emissions data associated to each process of bioproduct production at the site regarding at least one variable impacting emissions of the GHG (greenhouse gas) resulting from bioproduct generation at the site;
calculating, by means of the GHG (greenhouse gas) emissions modelling module, GHG (greenhouse gas) emissions data associated to each process of bioproduct production from at least one variable impacting emissions of the GHG (greenhouse gas) resulting from bioproduct generation at the site, and
calculating, by means of the GHG (greenhouse gas) emissions modelling module, a GHG (greenhouse gas) emissions level from the GHG (greenhouse gas) emissions data associated to each process of bioproduct production retrieved from the database by means of the GHG (greenhouse gas) emissions modelling module applying the following formula:

$${Emissions}_{Taski} = {\sum }_{i = 1}^{n} ( {ActivityData}_{i} \cdot {EmissionsFactor}_{i} )$$

where:
[Emissions Task]i is the GHG (greenhouse gas) emissions level,
[Activity data] is a characteristic parameter of an activity of equipment, installations and/or processes associated to the source material comprising the GHG (greenhouse gas) emissions associated to each process used to transform the source material into bioproduct, and
[Emission Factor] is the GHG (greenhouse gas) emissions data associated to each process used to transform the source material into bioproduct,
tagging the bioproduct produced with a label comprising said GHG (greenhouse gas) emissions level.

The method may preferably further comprise assigning a market value to each GHG (greenhouse gas) emissions level, preferably using the label comprising said GHG (greenhouse gas) emissions level.

The method preferably comprises selecting at least one client from a client database wherein said database comprises: client data, a GHG (greenhouse gas) emissions level range accepted by the at least one client and a market value range accepted by the at least one client.

The method comprises preferably distributing the produced bioproduct to the at least one client wherein said distribution is based on the a GHG (greenhouse gas) emissions level range accepted by the at least one client and/or the market value range accepted by the at least one client, in such a way that the at least one client is distributed only bioproduct with GHG (greenhouse gas) emissions level comprised in the GHG (greenhouse gas) emissions level range accepted by the at least client and/or market value comprised in the market value range accepted by the at least one client.

In yet another embodiment of the invention, the method accounts emissions derived from the production of other kinds of bioproduct, such as renewable electrical energy obtained from the raw material by a gasification process of said raw material. Gasification is the thermal conversion of the raw material used as feedstock into a gas, a synthesis gas called syngas (which as the skilled person would acknowledge is a fuel itself) said gas is then used for powering a cogeneration unit which produces renewable electrical energy (electricity) and/or renewable thermal energy (heat).

1. A system for measuring a GHG (greenhouse gas) emissions level in bioproduct production processes using a source material at a site, the system comprising:
at least a processing unit adapted to at least execute instructions related to the calculation of the GHG (greenhouse gas) emissions level in bioproduct production processes,
a plurality of sensors arranged along the site adapted to monitor, collect and report at least one variable related to GHG (greenhouse gas) emissions generated from the production of bioproduct at the site,
data transmission means adapted to transmit data and connected to the processing unit and at least to the plurality of sensors,
at least one database accessible by the processing unit by means of the data transmission means, and
a GHG (greenhouse gas) emissions modelling module embodied as software and connected to the processing unit and to at least one variable related to the GHG (greenhouse gas) emissions to produce GHG (greenhouse gas) emissions data associated to each process of bioproduct production at the site to generate a GHG (greenhouse gas) emissions level.

2. The system of claim 1, wherein the data regarding the at least one variable related to GHG (greenhouse gas) emissions generated from the production of bioproduct at the site collected by the plurality of sensors located at the site is included in the at least one database.

3. The system of claim 1, wherein the plurality of sensors are adapted to monitor and report data selected from the group consisting of a flow rate, temperature, pressure, weight, moisture, flow composition, energy exported, particulate matter, gas composition, energy produced, energy consumed, raw energy consumed, a waste stream, equipment emission value for at least one process used to transform the source material into bioproduct, installation emission value for at least one process used to transform the source material into bioproduct, process emission for at least one process used to transform the source material into bioproduct, and contaminant emission value for at least one process used to transform the source material into bioproduct.

4. The system of claim 1, wherein the at least one processing unit comprises:
at least one processor adapted to process at least the GHG (greenhouse gas) emissions data,
at least one memory connected to the at least one processor, and
storage means adapted to store at least the instructions executed by the at least one processor.

5. The system of claim 1, wherein the data transmission means is selected from the group consisting of: wired communication means, wireless communication means and near field communication means.

6. The system as in one of claims 1 to 5 wherein the bioproduct further comprises a co-product of bioproduct.

7. The system of claim 6 wherein the co-product is selected from the group consisting of: biofuels, bioliquids, biogas, chemicals, feed products, renewable electricity, renewable thermal energy, bioplastics, resins and CO2.

8. The system of claim 1 wherein the bioproduct is a biofuel.

9. The system according to claim 8 wherein the biofuel is bioethanol.

10. The system according to claim 8 wherein the biofuel is biodiesel.

11. The system of claim 1 wherein the bioproduct is a bioplastic.

12. The system according to claim 1, wherein the source material is selected from the group consisting of: cereals, sugar cane, straw, energy crops, forestry material, forestry residues organic waste, wine alcohol, aquaculture and fishery residues and oleaginous crops.

13. The system of claim 1, further comprising at least one interface to the processing unit, adapted to output a report of the GHG (greenhouse gas) emissions level.

14. The system of claim 1, wherein the GHG (greenhouse gas) emissions data associated to each process of bioproduct production at the site is selected from the group consisting of:
at least one emission factor to each process resulting from processing the at least one variable related to GHG (greenhouse gas) emissions produced by each bioproduct production process,
at least one activity data value resulting from processing the at least one variable related to GHG (greenhouse gas) emissions produced by each bioproduct production process,
at least one emission value resulting from processing the emission factor along with an activity data value, and
an emission level resulting from summing all the emission values.

15. A method for measuring GHG (greenhouse gas) emissions resulting from producing a bioproduct from a source material at a site, the method comprising:
retrieving from a plurality of sensors arranged along the site GHG (greenhouse gas) emissions data associated to each process of bioproduct production related to at least one variable impacting emissions of the GHG (greenhouse gas) resulting from bioproduct production at the site,
sending said GHG (greenhouse gas) emissions data associated to each process of bioproduct production at the site regarding at least one variable impacting emissions of the GHG (greenhouse gas) resulting from bioproduct generation at the site to a database accessible by at least a processing unit by means of transmission means to which said processing unit is connected,
retrieving, by means of a GHG (greenhouse gas) emissions modelling module embodied in software and connected to a processing unit capable of executing instructions embodied in said software, from the database said GHG (greenhouse gas) emissions data associated to each process of bioproduct production at the site regarding at least one variable impacting emissions of the GHG (greenhouse gas) resulting from bioproduct generation at the site;
calculating, by means of the GHG (greenhouse gas) emissions modelling module, GHG (greenhouse gas) emissions data associated to each process of bioproduct production from at least one variable impacting emissions of the GHG (greenhouse gas) resulting from bioproduct generation at the site, and
calculating, by means of the GHG (greenhouse gas) emissions modelling module, a GHG (greenhouse gas) emissions level from the GHG (greenhouse gas) emissions data associated to each process of bioproduct production retrieved from the database by means of the GHG (greenhouse gas) emissions modelling module applying the following formula:
$${Emissions}_{Taski} = {\sum }_{i = 1}^{n} ( {ActivityData}_{i} \cdot {EmissionsFactor}_{i} )$$
where:
(Emissions Task)i is the GHG (greenhouse gas) emissions level,
(Activity data) is a characteristic parameter of an activity of equipment, installations and/or processes associated to the source material comprising the GHG (greenhouse gas) emissions associated to each process used to transform the source material into bioproduct, and
(Emissions Factor) is the GHG (greenhouse gas) emissions data associated to each process used to transform the source material into bioproduct.

16. The method of claim 15, wherein the plurality of sensors are adapted to monitor and report data selected from the group consisting of a flow rate, temperature, pressure, weight, moisture, flow composition, energy exported, particulate matter, gas composition, energy produced, energy consumed, raw energy consumed, and waste stream.

17. The method of claim 15, wherein the process used to transform source material into bioproduct or to produce bioproduct is selected form the group consisting of: milling, mashing, cooking, liquefaction, fermentation, distillation, dehydration, boiler, cogeneration unit, gas turbine, steam turbine, feedstock preparation, biomass Pre-treatment, Solid/Liquid separation, gasification, cooling, gas cleaning, compression, catalysis reaction, enzymatic hydrolysis, selexol, transesterification, evaporation, mixing, drying, stripping, degumming, filtration, recovery, refining, purification, clarification, acid esterification, condensation, vents, and rectification.

18. The method of claim 15, wherein the GHG (greenhouse gas) emissions are expressed in g CO2 eq/MJ.

19. The method as in one of claims 15 to 18, wherein the bioproduct further comprises a co-product of bioproduct.

20. The method of claim 19 wherein the co-product is selected from the group consisting of: biofuels, bioliquids, biogas, chemicals, feed products, renewable electricity, renewable thermal energy, bioplastics, resins and CO2.

21. The method of claim 15 wherein the bioproduct is a biofuel.

22. The method of claim 21, wherein the biofuel is bioethanol.

23. The method of claim 21, wherein the biofuel is biodiesel.

24. The method of claim 15 wherein the bioproduct is a bioplastic.

25. The method of claim 15, wherein the source material is selected from the group consisting of: cereals, sugar cane, straw, energy crops, forestry material, forestry residues, organic waste, wine alcohol, aquaculture and fishery residues, oleaginous crops.

26. A method for measuring GHG (greenhouse gas) emissions resulting from producing bioproduct from a source material at a site, the method comprising managing bioproduct trading activities, the method comprising:
retrieving from a plurality of sensors arranged along the site GHG (greenhouse gas) emissions data associated to each process of bioproduct production related to at least one variable impacting emissions of the GHG (greenhouse gas) resulting from bioproduct production at the site,
sending said GHG (greenhouse gas) emissions data associated to each process of bioproduct production at the site regarding at least one variable impacting emissions of the GHG (greenhouse gas) resulting from bioproduct generation at the site to a database accessible by at least a processing unit by means of transmission means to which said processing unit is connected,
retrieving, by means of a GHG (greenhouse gas) emissions modelling module embodied in software and connected to a processing unit capable of executing instructions embodied in said software, from the database said GHG (greenhouse gas) emissions data associated to each process of bioproduct production at the site regarding at least one variable impacting emissions of the GHG (greenhouse gas) resulting from bioproduct generation at the site;
calculating, by means of the GHG (greenhouse gas) emissions modelling module, GHG (greenhouse gas) emissions data associated to each process of bioproduct production from at least one variable impacting emissions of the GHG (greenhouse gas) resulting from bioproduct generation at the site, and
calculating, by means of the GHG (greenhouse gas) emissions modelling module, a GHG (greenhouse gas) emissions level from the GHG (greenhouse gas) emissions data associated to each process of bioproduct production retrieved from the database by means of the GHG (greenhouse gas) emissions modelling module applying the following formula:
$${Emissions}_{Taski} = {\sum }_{i = 1}^{n} ( {ActivityData}_{i} \cdot {EmissionsFactor}_{i} )$$
where:
(Emissions Task)i is the GHG (greenhouse gas) emissions level,
(Activity data) is a characteristic parameter of an activity of equipment, installations and/or processes associated to the source material comprising the GHG (greenhouse gas) emissions associated to each process used to transform the source material into bioproduct, and
(Emission Factor) is the GHG (greenhouse gas) emissions data associated to each process used to transform the source material into bioproduct,
tagging the bioproduct produced with a label comprising said GHG (greenhouse gas) emissions level.

27. The method of claim 26 further comprising assigning a market value to each GHG (greenhouse gas) emissions level.

28. The method of claim 27 further comprising associating a market value to the produced bioproduct using the label comprising said GHG (greenhouse gas) emissions level.

29. The method of claim 26 comprising selecting at least one client from a client database wherein said database comprises: client data, a GHG (greenhouse gas) emissions level range accepted by the at least one client, and a market value range accepted by the at least one client.

30. The method of claim 29 comprising distributing the produced bioproduct to the at least one client wherein said distribution is based on the a GHG (greenhouse gas) emissions level range accepted by the at least one client and/or the market value range accepted by the at least one client, in such a way that the at least one client is distributed only bioproduct with GHG (greenhouse gas) emissions level comprised in the GHG (greenhouse gas) emissions level range accepted by the at least client and/or market value comprised in the market value range accepted by the at least one client.

31. The method of either of claim 15 or 26, wherein the source material is selected from the group consisting of: cereals, sugar cane, straw, energy crops, forestry material, forestry residues organic waste, wine alcohol, aquaculture and fishery residues and oleaginous crops.
